(19) United States
(12) Patent Application Publication
(10) Pub. No.: US 2025/0210225 A1
(43) Pub. Date: Jun. 26, 2025

(54) WIRE HARNESS ASSEMBLY

(71) Applicant: Yazaki Corporation, Tokyo (JP)

(72) Inventors: Koki ADACHI, Shizuoka (JP); Hiromichi Inoue, Shizuoka (JP); Ryo Hamada, Shizuoka (JP)

(73) Assignee: Yazaki Corporation, Tokyo (JP)

(21) Appl. No.: 18/978,686

(22) Filed: Dec. 12, 2024

(30) Foreign Application Priority Data
Dec. 20, 2023 (JP) 2023-215117

(51) Int. Cl. H01B 7/00

(52) U.S. Cl. CPC H01B 7/0045

(57) ABSTRACT

A wire harness assembly includes: a wire harness including an electric wire and a connector electrically connected to an end of the electric wire; and an assembly member in which the wire harness is arranged. The connector is arranged to be exposed to an outside of the assembly member. The assembly member has a pull-out portion configured to pull out the electric wire arranged inside the assembly member to the outside of the assembly member to change an arrangement position of the connector.

### CROSS-REFERENCE TO RELATED APPLICATIONS

The present application is based on and claims the benefit of priority from the prior Japanese Patent Application No. 2023-215117, filed on Dec. 20, 2023, the entire contents of which are incorporated by reference herein.

### TECHNICAL FIELD

The disclosure relates to a wire harness assembly.

### BACKGROUND

JP 2015-67071 A describes a wire harness assembly including a wire harness and an assembly sheet as an assembly member in which the wire harness is arranged, the wire harness including an electric wire and a connector electrically connected to an end of the electric wire. In the wire harness assembly, the connector of the wire harness is arranged to be exposed to the outside of the assembly sheet. In a state where the wire harness assembly is assembled to a target member, e.g., a door trim of a vehicle, the connector is fitted to a mating connector arranged in the target member. By fitting the connector to the mating connector, electrical components mounted on the vehicle are electrically connected to each other via the wire harness.

### SUMMARY

In the wire harness assembly described above, the arrangement position of the connector with respect to the assembly member is determined in accordance with a mating connector of a specific target member. Therefore, if the wire harness assembly is assembled to another target member, the connector may not be fitted to a mating connector because the mating connector is arranged at a different position. Therefore, it is necessary to create a wire harness assembly having a connector arranged at a different position for each target member to be assembled, and the wire harness assembly has low versatility.

The disclosure is directed to a wire harness assembly having improved versatility.

A wire harness assembly in accordance with some embodiments includes: a wire harness including an electric wire and a connector electrically connected to an end of the electric wire; and an assembly member in which the wire harness is arranged. The connector is arranged to be exposed to an outside of the assembly member. The assembly member has a pull-out portion configured to pull out the electric wire arranged inside the assembly member to the outside of the assembly member to change an arrangement position of the connector.

According to the above-described configuration, the versatility of the wire harness assembly can be improved.

### BRIEF DESCRIPTION OF THE DRAWINGS

FIG. 1 is a perspective view of a wire harness assembly according to an embodiment.

FIG. 2 is a top view of the wire harness assembly according to the present embodiment.

FIG. 3 is a top view of a cover of the wire harness assembly according to the present embodiment.

FIG. 4 is an enlarged top view of a main part of a separation portion and a restriction portion of the wire harness assembly according to the present embodiment.

FIG. 5 is an enlarged top view of a main part illustrating another example of a separation portion and a restriction portion of the wire harness assembly according to the present embodiment.

### DETAILED DESCRIPTION

Hereinafter, a wire harness assembly according to an embodiment will be described in detail with reference to the drawings. Note that dimensional ratios in the drawings are exaggerated for convenience of explanation, and may be different from actual ratios.

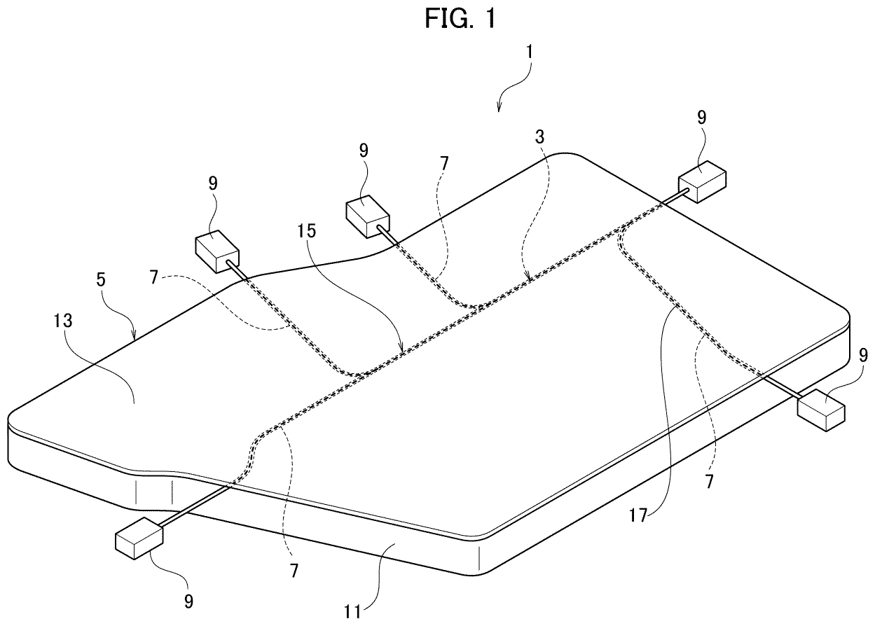

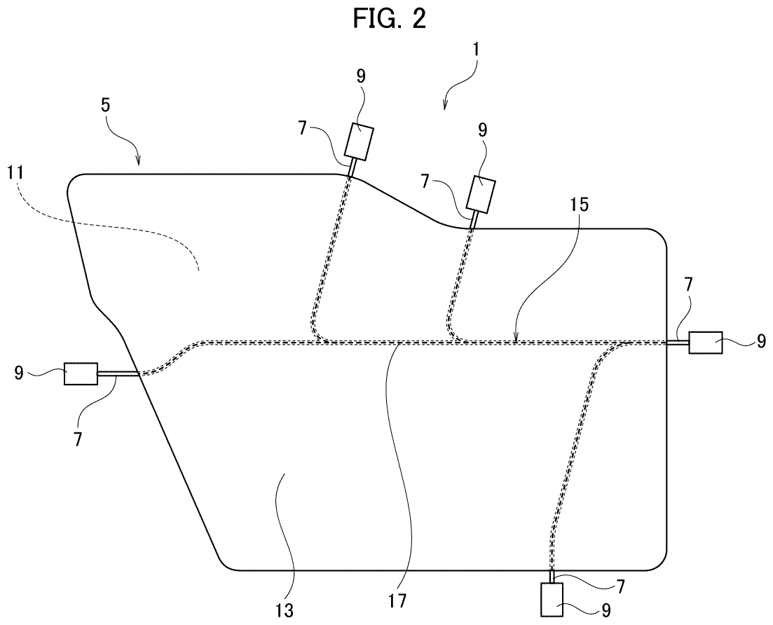

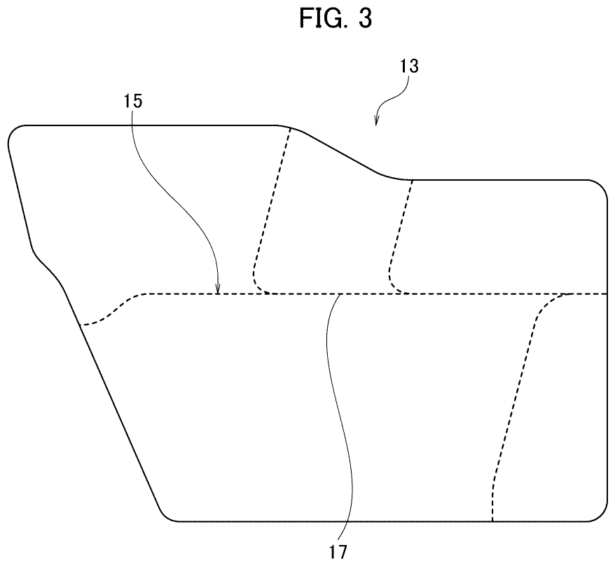

As illustrated in FIG. 1, the wire harness assembly 1 according to the present embodiment is applied to, for example, a wire harness 3 that electrically connects electrical components (not illustrated), e.g., a power supply mounted on a vehicle and a device or a device and a device. The wire harness 3 is arranged in a predetermined shape inside an assembly member 5 integrally assembled therewith. The wire harness assembly 1 is assembled to a target member (not illustrated), e.g., a door trim of a vehicle. As illustrated in FIGS. 1 to 4, the wire harness assembly 1 includes a wire harness 3 and an assembly member 5.

As illustrated in FIGS. 1 to 3, the wire harness 3 includes an electric wire 7 and a connector 9.

The electric wire 7 includes, for example, a sheathed electric wire in which an outer periphery of a core wire made of a conductive material is sheathed with an insulating sheath, and a plurality of (four in the present embodiment) electric wires 7 are used. The electric wire 7 may be a flat cable in which outer peripheries of a plurality of core wires are sheathed with an insulating sheath in a state where the plurality of core wires are arranged in parallel. The plurality of electric wires 7 are arranged in such a manner that ends on both sides thereof are exposed from the assembly member 5. The plurality of electric wires 7 are arranged in such a manner that the ends on one end sides are collected at one location, and the ends on the other end sides are branched.

The connector 9 includes, for example, a housing (not illustrated) made of an insulating material such as a synthetic resin, and a terminal (not illustrated) made of a conductive material. The housing can be fitted to, for example, a mating housing (not illustrated) of a mating connector (not illustrated) electrically connected to an electric component mounted on the vehicle. The terminal is electrically connected to the end of the electric wire 7, and is accommodated in the housing. The terminal is electrically connected to a mating terminal (not illustrated) accommodated in the mating housing by fitting the housing to the mating housing. A plurality of (five in the present embodiment) connectors 9 are used to correspond to the ends of the plurality of electric wires 7 exposed from the assembly member 5.

As illustrated in FIGS. 1 to 4, the assembly member 5 includes a base 11 and a cover 13.

The base 11 is made of, for example, a foam of urethane or the like, or a nonwoven fabric of polypropylene fibers, polyethylene terephthalate fibers, polyester-based fibers, or the like, and has soundproofing and heat insulating properties. The base 11 is formed in a sheet shape with a size set so that the base 11 is arranged within the range of the target member, and is assembled to the target member by a fixing means (not illustrated) such as press fitting. On one surface side of the base 11, the plurality of (four in the present embodiment) electric wires 7 of the wire harness 3 are arranged in a predetermined shape. The ends of the plurality of electric wires 7, each of the electric wires 7 being arranged on the base 11, are exposed from an outer edge of the base 11 with a predetermined length, and the connectors 9 are arranged outside the base 11.

The cover 13 is made of, for example, a film of vinyl chloride, polyethylene, or the like, or a closed-cell foam or an open-cell foam of polyethylene, polypropylene, polystyrene, elastomer, or the like, and has soundproofing and heat insulating properties. The cover 13 is formed in a sheet shape with a size set to be equal to that of the base 11 so that the cover 13 is arranged within the range of the target member, and a thickness set to be smaller than that of the base 11. An adhesive is applied onto a surface of the cover 13 facing the base 11. The cover 13 is attached to one surface side of the base 11 in such a manner that the plurality of electric wires 7 are sandwiched between the cover 13 and the base 11. In a state where the cover 13 is integrally attached to the base 11, the plurality of electric wires 7 arranged in a predetermined shape are held between the base 11 and the cover 13. Therefore, the assembly member 5 can protect the electric wire 7 of the wire harness 3, and maintain the arrangement shape of the electric wire 7.

The connector 9 exposed from the assembly member 5 is fitted to a mating connector in a state where the wire harness assembly 1 is assembled to the target member. At this time, since the electric wire 7 is exposed from the outer edge of the assembly member 5 with a predetermined length, the connector 9 can freely move, making it easy to fit the connector 9 to a mating connector. By fitting the connector 9 to the mating connector, electrical components are electrically connected to each other.

Here, in a conventional wire harness assembly, an arrangement position of a connector with respect to an assembly member is determined in accordance with a mating connector of a specific target member. Therefore, if the conventional wire harness assembly is assembled to another target member, the connector may not be fitted to a mating connector because the mating connector is arranged at a different position. The conventional wire harness assembly needs to be created with a connector arranged at a different position for each target member to be assembled, which results in low versatility.

On the other hand, in the wire harness assembly 1 according to the present embodiment, the assembly member 5 has a pull-out portion 15 capable of pulling out the electric wire 7 arranged inside the assembly member 5 to the outside of the assembly member 5 to change the arrangement position of the connector 9 with respect to the assembly member 5. In the following description, it is assumed that the pull-out portion 15 is provided in the cover 13, but the pull-out portion 15 may be provided in the base 11.

The pull-out portion 15 is provided in the cover 13 along the electric wire 7 in accordance with the arrangement shape of the electric wire 7. The pull-out portion 15 is formed as a separation portion 17 capable of tearing off the cover 13, for example, by forming cuts (notches) in the cover 13. The separation portion 17 is torn off by contact with the electric wire 7 by moving the electric wire 7 arranged inside the assembly member 5 toward the outside of the assembly member 5. The electric wire 7 that has torn off the separation portion 17 is pulled out to the outside of the assembly member 5, and the position of the end of the electric wire 7 exposed to the outside from the assembly member 5 is changed. When the position of the end of the electric wire 7 exposed from the assembly member 5 is changed, the length of the electric wire 7 pulled out to the outside of the assembly member 5 increases. When the length of the electric wire 7 pulled out by the pull-out portion 15 increases, the movable range of the connector 9 arranged outside the assembly member 5 increases, making it possible to change the arrangement position of the connector 9 with respect to the assembly member 5. Therefore, when the wire harness assembly 1 is assembled to a target member, even if a position of a mating connector is different, the connector 9 can be fitted to the mating connector by changing the arrangement position of the connector 9. Therefore, differences in arrangement position between mating connectors of target members can be absorbed, and the versatility of the wire harness assembly 1 can be improved. By forming the pull-out portion 15 as the separation portion 17 that can be torn off by contact with the electric wire 7, the structure of the pull-out portion 15 can be simplified, and the arrangement position of the connector 9 can be easily changed by moving the electric wire 7. In addition, by arranging the separation portion 17 along the electric wire 7, the movement of the electric wire 7 can be stably transmitted to the separation portion 17, and the electric wire 7 can be stably pulled out by tearing off the separation portion 17.

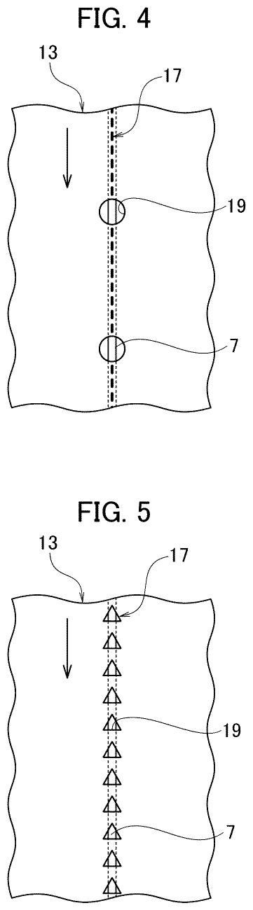

As illustrated in FIG. 4, the separation portion 17 includes a restriction portion 19 that restricts the tearing-off of the separation portion 17 by avoiding contact with the electric wire 7. The restriction portion 19 is formed in, for example, a circular shape set to have a larger diameter than the outer diameter of the electric wire 7, and is a hole formed through the cover 13. A plurality of restriction portions 19 are provided to be spaced apart from one another along the separation portion 17. For example, when the electric wire 7 is pulled out in a direction indicated by an arrow in FIG. 4 to tear off the separation portion 17, the electric wire 7 is arranged in the restriction portion 19 with the separation portion 17 being not in contact with the electric wire 7. When the electric wire 7 is arranged in the restriction portion 19, the separation portion 17 is not in contact with the electric wire 7, so that the tearing-off of the separation portion 17 can be terminated in the restriction portion 19. By providing the restriction portion 19 in the separation portion 17, the restriction portion 19 can be used as a guide for tearing off the separation portion 17, and assemblability can be improved. When the separation portion 17 is further torn off, the separation portion 17 can be torn off up to a next restriction portion 19 by further pulling out the electric wire 7 from the state in which the electric wire 7 is arranged in the restriction portion 19. As illustrated in FIG. 5, for example, the cuts (notches) of the separation portion 17 may have a triangular shape to serve as restriction portions 19. In the separation portion 17, the apexes of the cuts face the pull-out direction of the electric wire 7, which is a direction indicated by an arrow in FIG. 5, and the bottom sides of the cuts are set to be longer than the outer diameter of the electric wire 7. Therefore, the bottom sides of the triangles serve as restriction portions 19. By providing the separation portion 17 and the restriction portion 19 in this manner, the number of restriction portions 19 can be increased, and the arrangement position of the connector 9 with respect to the assembly member 5 can be finely adjusted.

The wire harness assembly 1 according to the present embodiment includes a wire harness 3 including an electric wire 7 and a connector 9 electrically connected to an end of the electric wire 7, and an assembly member 5 in which the wire harness 3 is arranged. The connector 9 is arranged to be exposed to the outside of the assembly member 5. The assembly member 5 has a pull-out portion 15 capable of pulling out the electric wire 7 arranged inside the assembly member 5 to the outside of the assembly member 5 to change the arrangement position of the connector 9.

In the electric wire 7 pulled out to the outside of the assembly member 5 by the pull-out portion 15, the length of the portion pulled out to the outside of the assembly member 5 increases. When the length of the electric wire 7 pulled out by the pull-out portion 15 increases, the movable range of the connector 9 arranged outside the assembly member 5 increases, making it possible to change the arrangement position of the connector 9 with respect to the assembly member 5. Therefore, when the wire harness assembly 1 is assembled to a target member, even if a position of a mating connector is different, the connector 9 can be fitted to the mating connector by changing the arrangement position of the connector 9.

Therefore, in the wire harness assembly 1, differences in arrangement position between mating connectors of target members can be absorbed, and versatility can be improved.

The pull-out portion 15 is a separation portion 17 to be torn off by contact with the electric wire 7 by moving the electric wire 7 arranged inside the assembly member 5 toward the outside of the assembly member 5.

Therefore, the structure of the pull-out portion 15 can be simplified, and the arrangement position of the connector 9 can be easily changed by moving the electric wire 7.

The separation portion 17 is arranged along the electric wire 7 arranged inside the assembly member 5.

Therefore, the movement of the electric wire 7 can be stably transmitted to the separation portion 17, and the electric wire 7 can be stably pulled out by tearing off the separation portion 17.

The separation portion 17 includes a restriction portion 19 that restricts the tearing-off of the separation portion 17 by avoiding contact with the electric wire 7.

Therefore, the restriction portion 19 can be used as a guide for tearing off the separation portion 17, and assemblability can be improved.

In the above-described embodiment, the pull-out portion 15 is the separation portion 17 to be torn off by contact with the electric wire 7, but the present invention is not limited thereto. For example, in a portion of the assembly member 5 where the end of the electric wire 7 is pulled out to the outside, the base 11 and the cover 13 are formed in a bag shape rather than bonding them to each other. An extra length portion of the electric wire 7 set to be long in advance is accommodated in the bag-shaped portion, so that the electric wire 7 can be pulled out to the outside. Such a bag-shaped portion may be used as the pull-out portion 15.

In the above-described embodiment, the number of the electric wires 7 in the wire harness 3 is four, but the present invention is not limited thereto, and the number of the electric wires 7 may be three or less or may be five or more. In the above-described embodiments, one end sides of the plurality of electric wires 7 are collected into one connector 9, but the present invention is not limited thereto, and the connector 9 may be provided on each of one end sides of the plurality of electric wires 7. The pull-out portion 15 may be provided in the assembly member 5 in accordance with such an electric wire 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wire harness assembly comprising:
a wire harness including an electric wire and a connector electrically connected to an end of the electric wire; and
an assembly member in which the wire harness is arranged, wherein
the connector is arranged to be exposed to an outside of the assembly member, and
the assembly member has a pull-out portion configured to pull out the electric wire arranged inside the assembly member to the outside of the assembly member to change an arrangement position of the connector.

2. The wire harness assembly according to claim 1, wherein the pull-out portion is a separation portion to be torn off by contact with the electric wire by moving the electric wire arranged inside the assembly member toward the outside of the assembly member.

3. The wire harness assembly according to claim 2, wherein the separation portion is arranged along the electric wire arranged inside the assembly member.

4. The wire harness assembly according to claim 2, wherein the separation portion includes a restriction portion configured to restrict tearing-off of the separation portion by avoiding contact with the electric wire.
